(19) United States
(12) Patent Application Publication
(10) Pub. No.: US 2026/0154175 A1
(43) Pub. Date: Jun. 4, 2026

(54) DATA STORAGE SYSTEM WITH BACKGROUND PROCESS SCHEDULING USING MODEL-BASED WORKLOAD ANALYZER TO DETECT PERIODS OF ANOMALOUS LOW ACTIVITY

(71) Applicant: Dell Products L.P., Round Rock, TX (US)

(72) Inventors: Ramakanth Kanagovi, Hyderabad (IN); Rajan Kumar, Nawada (IN); Guhesh Swaminathan, Chennai (IN)

(21) Appl. No.: 18/966,379

(22) Filed: Dec. 3, 2024

(51) Int. Cl. G06F 11/34; G06F 9/50

(52) U.S. Cl. CPC G06F 11/3433; G06F 9/5038; G06F 11/3447

(57) ABSTRACT

For scheduling background processes in a data storage system, feature data is continually collected for activity-indicating performance features over regular multi-hour sample periods, and collected feature data is provided to a model-based workload analyzer having (i) a features input layer employing weighted feature learning to generate a stream of feature vectors and (ii) a variational autoencoder (VAE) operable in response to the stream of feature vectors to generate a latent-space representation of the collected feature data having a normalized distribution. The latent-space representation is compared against a normalized threshold to identify periods of low activity, and based on the comparing the background processes are initiated during the identified periods of low activity.

### BACKGROUND

The invention is directed to the field of data storage systems, and in particular to the scheduling of background processes for execution in a data storage system.

### SUMMARY

A method of scheduling execution of background processes in a data storage system includes continually collecting feature data for performance features of data storage operations performed by the data storage system over regular multi-hour sample periods. Collected feature data is provided to a model-based workload analyzer having (i) a features input layer employing weighted feature learning to generate a stream of feature vectors and (ii) a variational autoencoder (VAE) operable in response to the stream of feature vectors to generate a latent-space representation of the collected feature data having a normalized distribution. The model-based workload analyzer is operated using the stream of feature vectors to generate the latent-space representation over the sample periods, and regularly comparing the latent-space representation against a predetermined normalized threshold to identify periods of low activity of the data storage system. Based on the comparing, execution of one or more of the background processes is initiated during the identified periods of low activity. Anomaly signals may be tracked in real-time, allowing for immediate identification of low-activity periods suitable for the background processes. Additionally, if a sub-sequence indicates a return to non-anomalous activity, the system can pause and checkpoint the background processes, ensuring that they can resume seamlessly once another low-activity period is detected. This real-time monitoring and dynamic adjustment can promote optimal resource utilization and minimal disruption to ongoing high-activity workloads.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a data processing system;

FIG. 2 is a functional block diagram of a model-based workload analyzer;

FIG. 3 is a flow diagram of a process or using the model-based workload analyzer for scheduling background process execution.

### DETAILED DESCRIPTION

### Overview

Background services (also called backend services) in data storage systems face challenges in determining optimal trigger times due to the high compute and resource demands required for service processes such as replication, backup, compression, archiving, tiering, etc. This issue is intensified in environments running highly active workloads, such as real-time data processing, financial transactions, and large-scale enterprise applications, which leave minimal windows for backend operations. In such dynamic environments, identifying periods of anomalously low activity becomes important for scheduling these resource-intensive services without disrupting primary workloads.

Traditional approaches in data storage systems offer basic functionalities for backend service management, but they are often limited by their incapacity to dynamically adjust to real-time changes, accurately predict optimal service periods, efficiently allocate resources, and scale effectively. These systems tend to be reactive rather than proactive; to rely heavily on static configurations and manual interventions; and to lack the flexibility and integration capabilities required for advanced anomaly detection and backend service scheduling.

An approach described herein addresses these limitations by incorporating a transformer-based variational autoencoder (VAE) architecture with real-time monitoring, dynamic adjustment, and integrated heuristic rules, providing a more efficient, scalable, and proactive approach to managing backend services in high-load storage environments. Specifically, the solution employs a novel approach using a transformers-based VAE model to detect anomaly signals in I/O activity and associated variables over time. One important aspect is the use of a weighted learning mechanism within timesteps, allowing for aggregated weighted average features at each timestep.

The model may be trained on non-anomalous samples, enabling a latent-space representation with predicted scalar value of 1, capturing the typical distribution of non-anomalous sub-sequences. This scalar prediction facilitates a proxy for anomaly detection, distinctly separating anomalous from non-anomalous sequences. During inference, any sub-sequence exhibiting a scalar value significantly deviating from the learnt scalar distribution (during training) triggers the backend services.

In one example the model may be trained on 1,000 highly active storage volumes created in a controlled lab environment, and tested on a large number (e.g., 200) sample periods of both high and low activity intervals. An anomaly detection recall of 90% and precision of 75% may be achievable. Anomaly signals are tracked in real-time, allowing for immediate identification of low-activity periods suitable for backend processes. If a sub-sequence indicates a return to non-anomalous activity, the system pauses and checkpoints the backend services, ensuring they can resume seamlessly once another low-activity period is detected. This real-time monitoring and dynamic adjustment ensure optimal resource utilization and minimal disruption to ongoing high-activity workloads.

Advantages of the approach can include the following:
Reduced Downtime: Ensures that backend services are triggered only during optimal periods, minimizing disruption to primary workloads.
Resource Optimization: Efficiently allocates compute and storage resources by accurately predicting low-activity windows.
Scalability: The model's ability to learn from and adapt to various workload patterns makes it suitable for diverse and large-scale storage environments.
Proactive Management: Enables proactive scheduling of backend services, enhancing overall system performance and reliability.

In specific aspects, a neural network architecture can be designed using other distilled methods, or distillation learning or quantization can be employed for more efficient inferencing based on resource constraints on the device. Inferencing can be performed either on the array (data storage system) or remotely (in the cloud). Heuristic rules of seasonality and cadence-based backend service triggering may be overlaid on top of the model's decisions.

Other specific aspects can include the following:
Transformers-Based VAE Architecture: The solution introduces a novel approach using a transformer-based variational autoencoder (VAE) model to detect anomaly signals in I/O activities and derived variables over time.
Weighted Features Learning Mechanism: One innovation is the introduction of a weighted learning mechanism within timesteps, allowing for aggregated weighted average features at each timestep.
Exclusive Non-Anomalous Training: The method may be trained exclusively on non-anomalous samples, using scalar predictions as a proxy for anomaly detection, ensuring precise separation of anomalous from non-anomalous sequences.
Real-Time Monitoring: Anomaly signals can be tracked in real-time, allowing immediate identification of periods suitable for backend processes.

Additional salient features of the technique can include the following:
Dynamic Adjustment: Pauses and checkpoints backend services during non-anomalous activity, ensuring seamless resumption during subsequent low-activity periods.
Reduced Downtime: Triggers backend services only during optimal periods, minimizing disruption to primary workloads.
Resource Optimization: Efficiently allocates compute and storage resources by accurately predicting low-activity windows.
Scalability: Adapts to various workload patterns, making it suitable for diverse and large-scale storage environments.
Proactive Management: Enables proactive scheduling of backend services, enhancing overall system performance and reliability.
Flexibility in Inference: Inference can be performed either on the array or via the cloud, depending on storage architecture decisions.
Heuristic Overlay: Allows overlay of heuristic rules of seasonality and cadence-based backend service triggering on top of the ML model's decisions.

### Embodiments

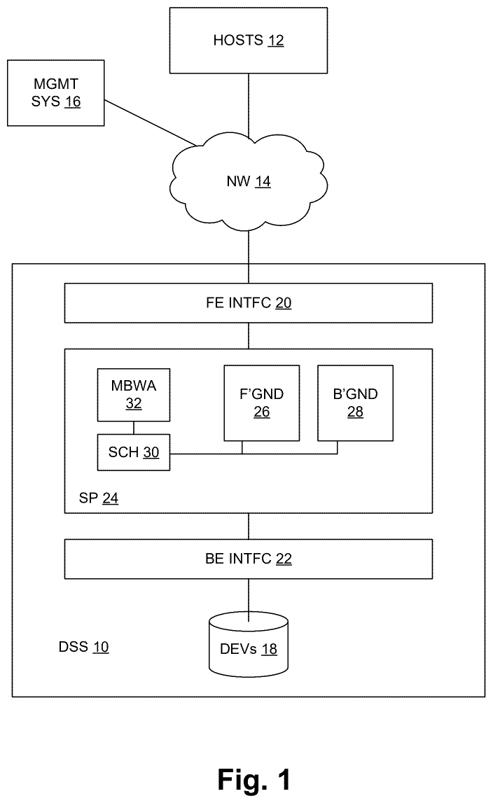

FIG. 1 shows a data processing environment in which a data storage system (DSS) 10 provides data storage services to separate host computers (hosts) 12 via a network 14. The system may also include a storage management system (MGMT SYS) 16 providing for remote management of the DSS 10 by a storage administrator. The DSS 10 includes storage devices (DEVs) 18 that provide persistent secondary storage of host data. It also includes front-end interface circuitry (FE INTFC) 20 providing a hardware and protocol interface to the network 14 and hosts 12, back-end interface circuitry (BE INTFC) 22 providing a hardware and protocol interface to the storage devices 18, and storage processing circuitry (SP) 24 that executes computer program instructions of a data storage application to realize a rich, complex set of data storage services and functions, as generally known. For present purposes, these services and functions are shown as being divided into foreground (F′GND) 26 and background (B′GND) 28 services and functions respectively. Example foreground processes 26 are those associated with active host requests such as host-commanded data read and write operations, while example background processes are those that may be completed outside of the context of an active host command, such as replication, backup, compression, etc. as mentioned above. Background processes are also referred to as “backend” processes herein.

The SP 24 also includes a scheduler (SCH) 30 responsible for scheduling execution of processes of the foreground 26 and background 28, and a model-based workload analyzer (MBWA) 32 that performs certain data gathering and analysis as described herein and provides input to the scheduler 30 to influence execution of background processes 28 for improved performance, as outlined above.

In one embodiment, the DSS 10 may be embodied in the form of PowerStore® data storage appliance as sold by Dell, Inc.

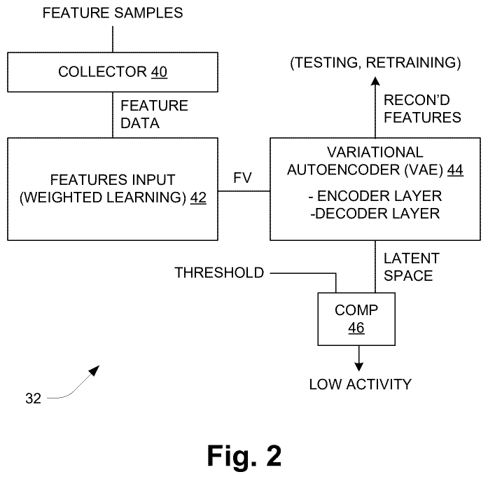

FIG. 2 shows details of the MBWA 32 of FIG. 1. It includes a collector 40, a weighted learning-based features input layer 42, and a variational autoencoder (VAE) 44, as well as comparator 46 used to compare a “latent space” output of the VAE 44 to a predetermined threshold value Threshold to generate a signal Low Activity that is provided to the scheduler 30 (FIG. 1). Operating modes of the MBWA include training and inferencing modes, wherein inferencing is based on parameters established in a preceding training phase. During inferencing, assertion of the Low Activity signal indicates detection of a period of anomalous low activity of the DSS 10, as described more fully below. Inferencing is used in regular ongoing operation of the DSS 10 for scheduling purposes, and it may also be used in testing in which its low-activity detection can be compared against other activity-level indicators so as to validate operation, such as by a human user employing system management tools at the management system 16.

Generally in operation, the collector 40 continually obtains data shown as “feature samples”, i.e., data describing various aspect of operation which are referred to as “features.” The collector 40 collects data for ongoing periods of predetermined length, such as 7-day periods for example, and makes each period's data available to the features input layer 42 as “feature data”. The features input layer 42 performs certain preprocessing of the feature data to generate a stream of feature vectors (FV) for the ongoing periods, and these are supplied to the VAE 44. The VAE 44 employs a set of transformers and associated logic to encode the feature vectors as respective normalized distributions in a latent-space representation. The comparator 46 compares the latent space output with the Threshold that represents separation between high and low activity levels (e.g., values above the Threshold represent high activity, and below-Threshold values represent low activity, in one embodiment). The comparator 46 asserts the Low Activity signal when the latent space output is below the Threshold.

As also shown, the VAE 44 may also produce reconstructed features (RECON′D FEATURES) by use of an internal VAE decoder (not shown) that operates on the latent-space representation from the VAE encoder, as generally known in the art. These may be used for testing and/or for retraining, either periodically or based on some other criteria.

In one embodiment, the features input layer 42 may have a two-stage arrangement in which an input stage collects feature samples for a period as described above, then employs a set of feed-forward neural net layers to the collected feature samples to generate a feature vector (FV) for the period. The VAE 44 operates to translate the feature vectors to corresponding normalized distributions in the latent space. Details of the feature samples and their processing are provided further below.

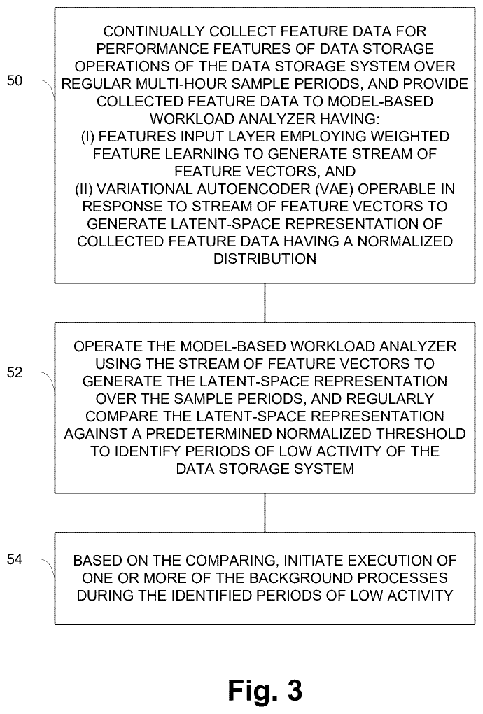

FIG. 3 illustrates pertinent operation at a high level, i.e., a method of scheduling execution of background processes (e.g., 28) in a data storage system (DSS).

At 50, the DSS continually collects feature data for performance features of data storage operations that are performed over regular multi-hour sample periods. Collected feature data is provided to a model-based workload analyzer (e.g., 32) that has (i) a features input layer (e.g., 42) employing weighted feature learning to generate a stream of feature vectors and (ii) a variational autoencoder (VAE) (e.g., 44) operable in response to the stream of feature vectors to generate a latent-space representation of the collected feature data having a normalized distribution.

At 52, the model-based workload analyzer is operated using the stream of feature vectors to generate the latent-space representation over the sample periods, and the latent-space representation is regularly compared against a predetermined normalized threshold to identify periods of low activity of the data storage system.

At 54, based on the comparing, execution of one or more of the background processes is initiated during the identified periods of low activity. This detection and use of periods of anomalously low activity promotes greater efficiency and better overall performance of the data storage system, especially with respect to its background operations.

### Example Detailed Solution Flow

In this section, various example details are provided for the types of features/variables to be monitored as well as example specifics of operating periods, etc.

The table below shows an example set of features, also referred to as machine-learning (ML) variables, that may be used in one embodiment. Each timestep (example 1 day) in a series of sequential multiple timesteps (example 7 days), features such as these that are representative of DSS activity are recorded, e.g., at a per-volume level. In one embodiment these variables and their values are recorded at more granular sub-timesteps (e.g., every 6 hours). The details and the reasoning for the need of sub-timesteps are explained in the architecture section below.

| Feature Name | Description |
|---|---|
| IOPS | IO per second over sample interval |
| Total Reads | Sum of read events |
| Total Writes | Sum of write events |
| Total Others (non-I/O) | Sum of all other events |
| Percentage reads (%) | % of reads events |
| Percentage writes (%) | % of write events |
| Percentage others (%) | % of other events |
| Average ‘read’ size | Average length of read IO |
| Average ‘write’ size | Average length of write IO |
| Std deviation of ‘read’ size | Standard deviation in read io length |
| Std deviation of ‘write’ size | Standard deviation in write IO length |
| Time consecutive I/Os (avg) | Average interarrival rate of any IO |
| Time consecutive reads (avg) | Average interarrival rate of read IO |
| Time consecutive writes (avg) | Average interarrival rate of write IO |
| Delta consecutive I/Os (avg) | Average difference in LBA between IO |
| Delta consecutive reads (avg) | Average difference in LBA between reads |
| Delta consecutive writes (avg) | Average difference in LBA between writes |
| Consecutive read-read (%) | % of consecutive IO pairs that are both read |
| Consecutive read-write (%) | % of consecutive IO pairs that are read followed by write |
| Consecutive write-read (%) | % of consecutive IO pairs that are write followed by read |
| Consecutive write-write (%) | % of consecutive IO pairs that are both write |
| Sequential read (%) | % of consecutive read pairs such that the 2nd one begins at the |
| | address where the 1st one ended (i.e. LBA + size) |
| Sequential write (%) | % of consecutive write pairs such that the 2nd one begins at the |
| | address where the 1st one ended (i.e. LBA + size) |
| Immediate write-over-read | % of consecutive IO pairs that are read followed by write, and |
| | the write is over the same address range as the read. |
| Delayed write-over-read | % of IO pairs in a sequence of size N (e.g., N = 100) that are read |
| | followed by write over the same address range. |
| Frequency | The number of IO operations happening in the train interval |
| | within the specific storage object |
| Recency | The latest time interval of IO operation happening in the train |
| | interval within the specific storage object |
| First | The first-time interval of IO operation happening in the train |
| | interval within the specific storage object |

### Training Process

1. Data Collection:
   a. Capture all features mentioned in the table over a 6-hour interval each day for 7 days.
   b. This results in 4×7=28 timesteps of data for each of the features
2. Data Preparation:
   a. Select 1000 highly active volumes for training.
   b. Organize the data into the specified timestep fashion.
3. Model Architecture:
   a. Features Input Layer: Weighted Features Learning Mechanism
      i. Implement a feedforward neural network layer.
      ii. Include normalization and regularization layers.
      iii. Learn weights for each 6-hour timestep within a given day.
   b. Transformer VAE Block:
      i. Train the VAE to learn latent features while trying to reconstruct the input.
   c. Latent Feature Representation:
      i. Use the lower-dimensional space representation from the VAE.
      ii. Feed these representations into additional feedforward neural layers to predict a scalar value of 1.
4. Training Objective:
   a. The scalar value of 1 represents good sequences of high active volumes.
   b. Train the model to recognize and predict this scalar value, thus learning the distribution of good sequences.

### Testing and Inference Process

5. Input Data:
   a. For testing, input a sequence of 7 days of multi-feature data into the model.
6. Output Evaluation:
   a. The model outputs a scalar value.
   b. Evaluate the output by checking its distance from the central value of the trained scalar distribution.
   c. If the output is too far from the central value, it is considered an anomaly; otherwise, it is normal.

### Performance Metrics

7. Test Sample:
   a. Test the model on 200 samples, comprising 190 high active and 10 low active volumes.
8. Evaluation:
   a. Check correct prediction rate (e.g., high % of samples)
   b. Check volume activity prediction rate (e.g., high % of low-active volumes)
   c. Check recall for anomaly detection (e.g., 90%)
   d. Check precision (e.g., 75%)

### Summary of Example Process

The above example process/architecture is summarized as follow:
1. Capture features over a 6-hour interval for 7 days.
2. Organize data into 168 timesteps for each of the 28 features.
3. Select 1000 highly active volumes for training.
4. Build a feedforward neural network with normalization and regularization.
5. Implement a Transformer VAE block for latent feature learning.
6. Use latent features to predict a scalar value of 1.
7. Train the model to recognize and predict good sequences.
8. Test the model with 7 days of multi-feature data sequences.
9. Evaluate the output scalar value against the trained distribution.
10. Identify anomalies based on the distance from the central scalar value.
11. Test on 200 samples and calculate recall and precision.
12. Create a confusion matrix to assess performance metrics.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

While various embodiments of the invention have been particularly shown and described, it will be understood by those skilled in the art that various changes in form and details may be made therein without departing from the scope of the invention as defined by the appended claims.

What is claimed is:

1. A method of scheduling execution of background processes in a data storage system, comprising:
continually collecting feature data for performance features of data storage operations performed by the data storage system over regular multi-hour sample periods, and providing collected feature data to a model-based workload analyzer, the model-based workload analyzer having (i) a features input layer employing weighted feature learning to generate a stream of feature vectors and (ii) a variational autoencoder (VAE) operable in response to the stream of feature vectors to generate a latent-space representation of the collected feature data having a normalized distribution;
operating the model-based workload analyzer using the stream of feature vectors to generate the latent-space representation over the sample periods, and regularly comparing the latent-space representation against a predetermined normalized threshold to identify periods of low activity of the data storage system; and
based on the comparing, initiating execution of one or more of the background processes during the identified periods of low activity.

2. The method of claim 1, wherein the VAE employs a transformers-based VAE model to detect anomaly signals in I/O activity and associated variables over time.

3. The method of claim 2, wherein the VAE model is trained exclusively on non-anomalous samples and employs the latent-space representation with predicted scalar value of 1 capturing a typical distribution of non-anomalous sub-sequences, and during subsequent inferencing, a low-activity period is detected by a sub-sequence exhibiting a scalar value significantly deviating from the scalar distribution learned during training.

4. The method of claim 3, wherein the model is trained on a plurality of highly active storage volumes in an operating environment, and tested on a plurality of sample periods of both high and low activity intervals.

5. The method of claim 3, further including, based on a sub-sequence indicating a return to non-anomalous activity, pausing and checkpointing the background processes in a manner ensuring they can be resumed seamlessly once another low-activity period is detected.

6. The method of claim 1, wherein the background processes are those that can be completed outside of the context of an active host command, including one or more of replication, backup, compression, archiving, and tiering.

7. The method of claim 1, wherein the feature data is collected at more-granular sub-timesteps within the multi-hour sample periods, and is collected at a per-volume level for a plurality of data storage volumes of the data storage system.

8. The method of claim 7, wherein the per-volume feature data includes features for read and write operations including (i) total numbers of read and write operations, (ii) percentages of read and write operations, (iii) measures of sizes of read and write operations, (iv) measures of consecutiveness and sequentiality of read and write operations.

9. A data storage system, comprising:
storage devices configured and operative to provide persistent secondary storage of host data; and
storage processing circuitry configured and operative to store and execute computer program instructions of a data storage application including scheduling of execution of background processes by:
continually collecting feature data for performance features of data storage operations performed by the data storage system over regular multi-hour sample periods, and providing collected feature data to a model-based workload analyzer, the model-based workload analyzer having (i) a features input layer employing weighted feature learning to generate a stream of feature vectors and (ii) a variational autoencoder (VAE) operable in response to the stream of feature vectors to generate a latent-space representation of the collected feature data having a normalized distribution;
operating the model-based workload analyzer using the stream of feature vectors to generate the latent-space representation over the sample periods, and regularly comparing the latent-space representation against a predetermined normalized threshold to identify periods of low activity of the data storage system; and
based on the comparing, initiating execution of one or more of the background processes during the identified periods of low activity.

10. The data storage system of claim 9, wherein the VAE employs a transformers-based VAE model to detect anomaly signals in I/O activity and associated variables over time.

11. The data storage system of claim 10, wherein the VAE model is trained exclusively on non-anomalous samples and employs the latent-space representation with predicted scalar value of 1 capturing a typical distribution of non-anomalous sub-sequences, and during subsequent inferencing, a low-activity period is detected by a sub-sequence exhibiting a scalar value significantly deviating from the scalar distribution learned during training.

12. The data storage system of claim 11, wherein the model is trained on a plurality of highly active storage volumes in an operating environment, and tested on a plurality of sample periods of both high and low activity intervals.

13. The data storage system of claim 11, wherein, based on a sub-sequence indicating a return to non-anomalous activity, pausing and checkpointing the background processes in a manner ensuring they can be resumed seamlessly once another low-activity period is detected.

14. The data storage system of claim 9, wherein the background processes are those that can be completed outside of the context of an active host command, including one or more of replication, backup, compression, archiving, and tiering.

15. The data storage system of claim 9, wherein the feature data is collected at more-granular sub-timesteps within the multi-hour sample periods, and is collected at a per-volume level for a plurality of data storage volumes of the data storage system.

16. The data storage system of claim 15, wherein the per-volume feature data includes features for read and write operations including (i) total numbers of read and write operations, (ii) percentages of read and write operations, (iii) measures of sizes of read and write operations, (iv) measures of consecutiveness and sequentiality of read and write operations.

17. A non-transitory computer-readable medium storing computer program instructions which, when executed by storage processing circuitry of a data storage system, cause the data storage system to operate according to a method of scheduling execution of background processes in the data storage system, the method including:
continually collecting feature data for performance features of data storage operations performed by the data storage system over regular multi-hour sample periods, and providing collected feature data to a model-based workload analyzer, the model-based workload analyzer having (i) a features input layer employing weighted feature learning to generate a stream of feature vectors and (ii) a variational autoencoder (VAE) operable in response to the stream of feature vectors to generate a latent-space representation of the collected feature data having a normalized distribution;
operating the model-based workload analyzer using the stream of feature vectors to generate the latent-space representation over the sample periods, and regularly comparing the latent-space representation against a predetermined normalized threshold to identify periods of low activity of the data storage system; and
based on the comparing, initiating execution of one or more of the background processes during the identified periods of low activity.

18. The non-transitory computer-readable medium of claim 17, wherein the VAE employs a transformers-based VAE model to detect anomaly signals in I/O activity and associated variables over time.

19. The non-transitory computer-readable medium of claim 18, wherein the VAE model is trained exclusively on non-anomalous samples and employs the latent-space representation with predicted scalar value of 1 capturing a typical distribution of non-anomalous sub-sequences, and during subsequent inferencing, a low-activity period is detected by a sub-sequence exhibiting a scalar value significantly deviating from the scalar distribution learned during training.

20. The non-transitory computer-readable medium of claim 19, wherein the model is trained on a plurality of highly active storage volumes in an operating environment, and tested on a plurality of sample periods of both high and low activity intervals.
